(19) United States
(12) Patent Application Publication
(10) Pub. No.: US 2009/0302162 A1
(43) Pub. Date: Dec. 10, 2009

(54) PASSIVE VARIABLE SPEED DROGUE

(75) Inventors: Eric Reed, Kingman, AZ (US); William L. Kirkland, Kingman, AZ (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: WEST COAST NETTING, INC., Kingman, AZ (US)

(21) Appl. No.: 12/477,696

(22) Filed: Jun. 3, 2009

Related U.S. Application Data
(60) Provisional application No. 61/058,859, filed on Jun. 4, 2008.

(51) Int. Cl. B64D 39/00

(52) U.S. Cl. 244/135 A

(57) ABSTRACT

The passive variable speed drogue includes an articulated center strut lever linkage assembly pivotally connected between adjacent pairs of center struts and trailing edge struts, biased by an extension spring mounted to the center strut to move the center strut to a required stop position to maintain substantially constant loads on the drogue within a range of refueling speeds, and to permit improved interfacing of the variable speed drogue assembly with a stowage tube. A center strut bumper on the center strut also provides improved interfacing of the variable speed drogue assembly with a stowage tube.

### CROSS-REFERENCES TO RELATED APPLICATIONS

This application is based upon U.S. provisional Application No. 61/058,859, filed Jun. 4, 2008, which is incorporated by reference in its entirety.

### BACKGROUND OF THE INVENTION

This invention relates generally to aerodynamic drogues for aerial inflight refueling, and more particularly concerns an improved aerial inflight refueling drogue assembly having a spring biased center strut lever linkage assembly that biases the center strut to move to a required stop position to maintain substantially constant loads and improve drogue stability within a range of refueling speeds, and to permit improved interfacing of the variable speed drogue assembly with a stowage tube.

The development of drogues for inflight refueling of aircraft has been primarily directed by the need to stabilize a refueling hose trailing from a tanker aircraft in a generally horizontal and vertical attitude. The drogue provides drag for the refueling coupling, which must resist the forward movement of a probe from a refueling aircraft. Cone shaped drogues have proved to be suitable for low and high speed inflight refueling; however, it has been found that such drogues can show some signs of instability at higher speeds, causing the refueling coupling device at the end of the refueling hose to show signs of instability, and occasionally causing the structure of the cone shaped drogue to collapse.

The high amount of drag provided by a drogue for low speed refueling also can cause the trail angle of the refueling hose and coupling to become flattened. It is desirable that the refueling aircraft not follow directly in the wake of the tanker aircraft, and a fixed configuration of a drogue, which may be appropriate for low air speed refueling, can be inappropriate for high speed refueling, even if the motion of the refueling coupling can be stabilized by aerodynamic designs.

It has therefore been a common practice to install either a low or high speed configuration drogue on the refueling coupling of a tanker aircraft on the ground, depending upon whether the aerial refueling is to take place at low or high speed, and to land to change the drogue to one of another speed configuration when an aircraft needs to be refueled at a different speed. Another approach has been to fabricate the ring shaped parachute canopy of the drogue of elastic material with openings which permit pressure modulation to provide for a constant amount of drag over varying speeds. However, such elastic openings have been found to be subject to deterioration, which can cause the amount of drag provided by the drogue to decrease over time, and can also cause an asymmetrical drag configuration to develop.

There is therefore a continuing need for a variable speed drogue which can maintain a substantially constant load on the drogue over a wider range of refueling speeds, and which is not generally susceptible to deterioration or damage from a refueling probe. It would also be desirable to provide a refueling drogue system that requires no modifications to a refueling tanker aircraft, that can be bolted onto a conventional coupling for conventional drogue frames and drogues, and that will permit refueling to be done from the lowest through the highest aircraft refueling speeds.

It therefore would be desirable to provide a variable speed drogue that improves stability and canopy inflation during deployment at all speeds, and the ability of the drogue system to collapse the drogue assembly and enter a stowage tube, for improved interfacing with a stowage tube. The present invention meets these and other needs.

### SUMMARY OF THE INVENTION

Briefly, and in general terms, the present invention provides for a passive variable speed drogue that provides stability and remains inflated throughout a range of refueling speeds, and that provides improved interfacing of the variable speed drogue assembly with a stowage tube. The passive variable speed drogue includes an articulated center strut lever linkage assembly pivotally connected between adjacent pairs of center struts and trailing edge struts, with an extension spring that biases the center strut to move to a required stop position, holds the center strut in the required stop position in a desired relationship with the trailing edge strut to maintain substantially constant loads on the drogue within a range of refueling speeds, enhances the ability of the drogue to inflate rapidly during hose-drogue deployment, and permits improved interfacing of the variable speed drogue assembly with a stowage tube. A radially outwardly extending center strut bumper is also provided on the center strut to further facilitate improved interfacing of the variable speed drogue assembly with the stowage tube. The aerial refueling drogue system does not require modification to a refueling tanker aircraft, and can be mounted to a conventional coupling for conventional drogue frames and drogues.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic sectional elevational view of the passive variable speed drogue for inflight refueling of aircraft according to the invention, shown connected to an inflight aerial refueling system.

FIG. 2 is an enlarged schematic sectional elevational view of the passive variable speed drogue of FIG. 1 in a folded configuration for placement within the confines of a stowage tube.

FIG. 3 is an enlarged schematic sectional elevational view of the passive variable speed drogue of FIG. 1 in an open deployed configuration.

### DETAILED DESCRIPTION OF THE PREFERRED EMBODIMENTS

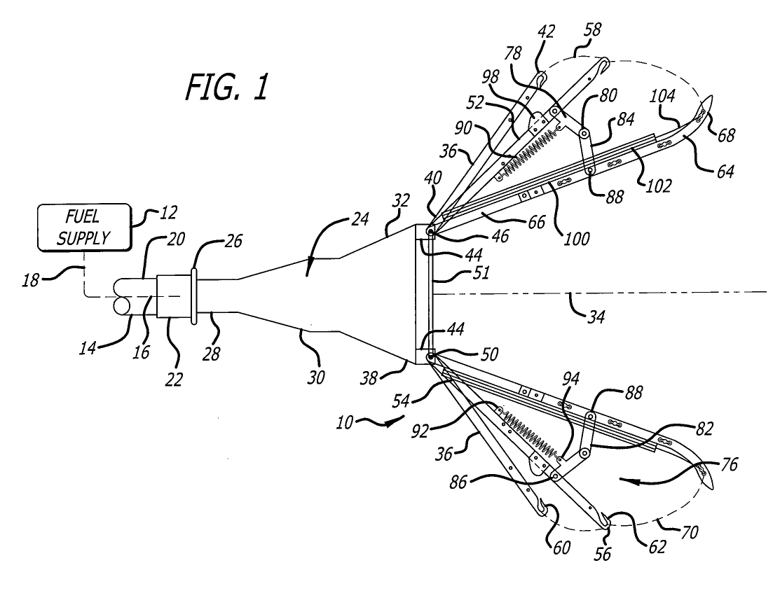

Referring to FIGS. 1-3, which are provided by way of example, and not by way of limitation, the present invention provides for a passive variable speed drogue 10 for use with an inflight aerial refueling system. With reference to FIG. 1, the inflight aerial refueling system typically includes a fuel supply 12, such as a fuel tank in a tanker aircraft, an aircraft drogue stowage tube (not shown) which can be mounted in a wing pod or fuselage of a tanker aircraft for stowing the drogue, and a fuel line 14 that can be extended and retracted during flight for refueling other aircraft, that is connected for fluid communication with the fuel supply. The fuel line has a longitudinal axis 16, a leading end 18 connected to the tanker aircraft fuel supply, and a trailing end 20 connected to the forward end 22 of a refueling coupling member 24. The refueling coupling member is generally hollow and conical in shape, having a forward mating end portion 26 attached to the fuel line, a tubular intermediate section 28, a tapered intermediate throat section 30 flaring outward slightly to the rear of the tubular intermediate section to guide a refueling probe (not shown) of an aircraft that is refueling, and a funnel shaped, tapered mouth portion 32 flaring outwardly at the rearward end of the refueling coupling member for receiving the refueling probe. The longitudinal axis of the fuel line is generally in line with the longitudinal axis 34 of the refueling coupling member where they are joined together.

A plurality of leading edge struts 36 are pivotally mounted to the trailing edge portion 38 of the refueling coupling member. The leading edge struts each have a leading end 40 and a trailing end 42. The trailing edge portion of the refueling coupling member preferably includes a plurality of flanges 44 symmetrically arrayed around the trailing edge portion of the refueling coupling member, each of the flanges having an aperture 46 for mounting of the leading edge struts. The leading ends of the leading edge struts include an aperture 50 aligned with the aperture of the flanges for pivotally mounting of the leading edge struts, such as by an attachment ring 51, for example, or the like.

A plurality of center struts 52, each having a leading end 54 and a trailing end 56, are pivotally mounted in the same manner as the leading edge struts to the trailing edge portion of the refueling coupling member extending radially inwardly and rearward of the leading edge struts. A forward drogue canopy 58 is fixedly attached between the trailing end of the leading edge struts and the trailing end of the center struts. The trailing ends of the leading edge struts typically include hooks 60 for attaching the forward drogue canopy, although the drogue canopy may be attached by other suitable means, such as by a cord, cable, hooks or loops, or the like. The trailing ends of the center struts similarly preferably include hooks 62 for attaching the drogue canopy member in the same fashion. The forward drogue typically is responsible for most required load for high speed refueling.

A plurality of trailing edge struts 64, each having a leading end 66 and a trailing end 68, are also pivotally mounted in the same manner as the leading edge and center struts to the trailing edge portion of the refueling coupling member. An aft bleeding drogue canopy 70 extends between the center struts and the trailing edge struts. The aft bleeding drogue canopy is typically also attached to the aperture at the end of the center strut such as by a cord, cable, hooks or loops, or the like.

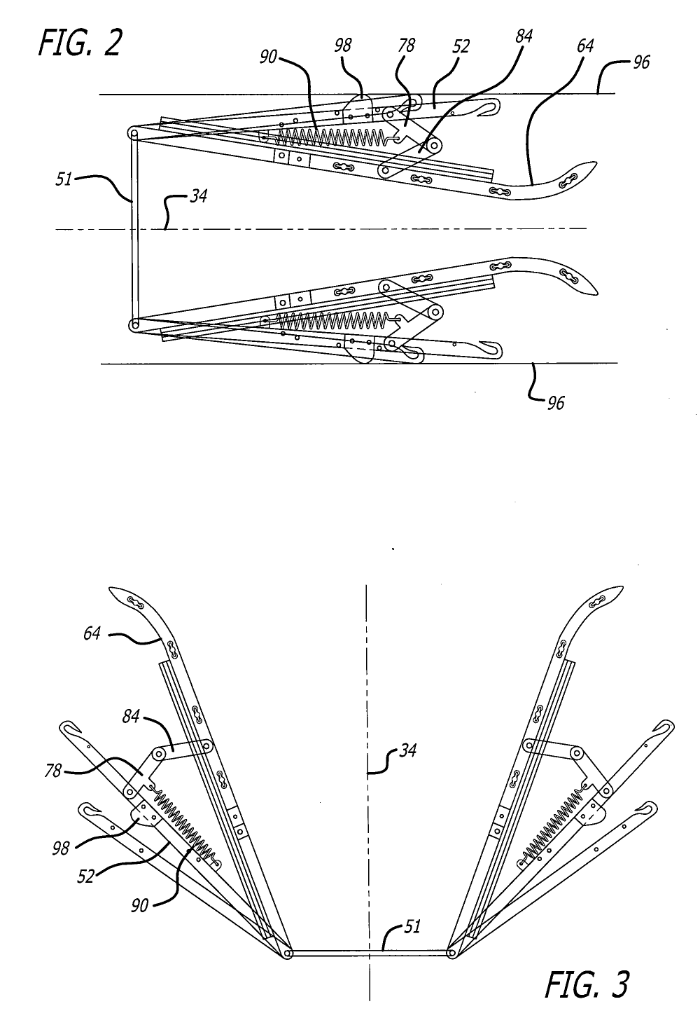

Referring to FIGS. 1-3, an articulated center strut lever linkage assembly 76 is pivotally connected between adjacent pairs of center struts and trailing edge struts. Each center strut lever linkage assembly includes a center strut lever 78 having a radially inward end pivotally connected at a center pivot point 80 to a radially outward end 82 of a trailing edge strut brace 84. The radially outward end 86 of each center strut lever arm is pivotally connected to a corresponding center strut, and the radially inward end 88 of each trailing edge strut brace is pivotally connected to a corresponding trailing edge strut. An extension spring 90 is connected between a spring connector flange 92 on the center strut lever and a radially inwardly projecting spring attachment flange 94 mounted on the center strut. The extension spring biases the center strut to move to a required stop position, holds the center strut in the required stop position in a desired drogue open relationship with the trailing edge strut, and permits improved interfacing of the variable speed drogue assembly with a stowage tube, schematically represented in FIG. 2 by lines 96. A radially outwardly extending center strut bumper 98 is also preferably mounted to each center strut to interface with a stowage tube, and prevents the canopy from being pinched between the stowage tube and the center strut tip.

With reference to FIGS. 1-3, each of the trailing edge arms may also include a hollow spring chamber 100 in which an aft bleeding drogue canopy coil spring 102 is mounted, and a cord 104 is connected between the aft bleeding drogue canopy coil spring and the aft bleeding drogue canopy. The cord can be suitably attached to the bleeding drogue canopy by a ring, cord, cable, hooks or loops, or the like. The aft bleeding drogue canopy thus is movable between a first folded configuration illustrated in FIG. 2, in which the aft bleeding drogue canopy coil springs are retracted, and a second open deployed configuration illustrated in FIG. 3, in which the aft bleeding drogue canopy coil springs are extended. The projected area of the aft bleeding drogue canopy thus varies between a minimum projected area in the first folded configuration and a maximum projected area in the second open extended position. Over a range of refueling speeds, the aft bleeding drogue extends as the speed increases and the load on the aft bleeding drogue increases, and retracts as the speed decreases and the load on the aft bleeding drogue decreases, to maintain substantially constant loads on the aft bleeding drogue within the range of refueling speeds. Alternatively, it should be appreciated that the aft bleeding drogue canopy coil springs could be mounted in the center struts (not shown), connecting the aft bleeding drogue canopy between the trailing end of the center struts and the trailing end of the trailing edge struts.

It should also be appreciated that the leading edge, center, and trailing edge struts may be limited in their outward extension by extension limiting means such as cables connecting adjacent trailing edge struts to each other at intermediate points along the length the trailing edge struts.

It will be apparent from the foregoing that while particular forms of the invention have been illustrated and described, various modifications can be made without departing from the spirit and scope of the invention. Accordingly, it is not intended that the invention be limited, except as by the appended claims.

We claim:

1. A passive variable speed drogue configured to be stowed in a stowage tube of an aircraft inflight aerial refueling system, said system including a fuel supply, a fuel line having leading and trailing ends and being in fluid communication with said fuel supply, and a refueling coupling member for receiving a refueling probe, said refueling coupling member having a longitudinal axis, a forward end and a rearward end, and a trailing edge portion at said rearward end, said refueling coupling member forward end being mounted to said trailing end of said fuel line, the passive variable speed drogue comprising:
a plurality of leading edge struts pivotally mounted to the trailing edge portion of the refueling coupling member, said plurality of leading edge struts each having a leading end and a trailing end;
a plurality of center struts pivotally mounted to the trailing edge portion of the refueling coupling member and extending radially inwardly and rearward of the leading edge struts, each of said plurality of center struts having a leading end and a trailing end;
a forward drogue canopy fixedly attached between the trailing ends of the plurality of leading edge struts and the trailing ends of the plurality of center struts;
a plurality of trailing edge struts pivotally mounted to the trailing edge portion of the refueling coupling member, each of said plurality of trailing edge struts having a leading end and a trailing end;
an aft bleeding drogue canopy attached between said plurality of center struts and said plurality of trailing edge struts; and
a plurality of articulated center strut lever linkage assemblies pivotally connected between a plurality of corresponding adjacent pairs of one of said plurality of center struts and one of said plurality of trailing edge struts, respectively.

2. The passive variable speed drogue of claim 1, wherein each of said center strut lever linkage assemblies comprises a center strut lever arm and a trailing edge strut brace, said center strut lever arm having a radially inward end and a radially outward end, said trailing edge strut brace having a radially inward end and a radially outward end, and said center strut lever arm being pivotally connected at a center pivot point to said radially outward end of said trailing edge strut brace.

3. The passive variable speed drogue of claim 2, wherein said radially outward end of each center strut lever arm is pivotally connected to a corresponding one of said plurality of center struts.

4. The passive variable speed drogue of claim 2, wherein said radially inward end of each trailing edge strut brace is pivotally connected to a corresponding one of said plurality of trailing edge struts.

5. The passive variable speed drogue of claim 2, further comprising an extension spring connected between each said center strut lever arm and a corresponding one of said plurality of center struts, said extension spring being configured to bias said corresponding one of said plurality of center struts to a required stop position in a desired drogue open relationship with a corresponding one of said plurality of trailing edge struts.

6. The passive variable speed drogue of claim 2, each of said plurality of center struts further comprising a radially outwardly extending center strut bumper configured to interface with a stowage tube.

7. The passive variable speed drogue of claim 1, each of said plurality of trailing edge arms further comprising a hollow spring chamber housing an aft bleeding drogue canopy coil spring, and a cord connected between said aft bleeding drogue canopy coil spring and said aft bleeding drogue canopy.

8. The passive variable speed drogue of claim 7, wherein said aft bleeding drogue canopy is movable between a first folded configuration and a second open deployed configuration, said aft bleeding drogue canopy coil springs being retracted in said first folded configuration, and said aft bleeding drogue canopy coil springs being extended in said second open deployed configuration.

9. A passive variable speed drogue configured to be stowed in a stowage tube of an aircraft inflight aerial refueling system, said system including a fuel supply, a fuel line having leading and trailing ends and being in fluid communication with said fuel supply, and a refueling coupling member for receiving a refueling probe, said refueling coupling member having a longitudinal axis, a forward end and a rearward end, and a trailing edge portion at said rearward end, said refueling coupling member forward end being mounted to said trailing end of said fuel line, the passive variable speed drogue comprising:
a plurality of leading edge struts pivotally mounted to the trailing edge portion of the refueling coupling member, said plurality of leading edge struts each having a leading end and a trailing end;
a plurality of center struts pivotally mounted to the trailing edge portion of the refueling coupling member and extending radially inwardly and rearward of the leading edge struts, each of said plurality of center struts having a leading end and a trailing end;
a forward drogue canopy fixedly attached between the trailing ends of the plurality of leading edge struts and the trailing ends of the plurality of center struts;
a plurality of trailing edge struts pivotally mounted to the trailing edge portion of the refueling coupling member, each of said plurality of trailing edge struts having a leading end and a trailing end, each of said plurality of trailing edge arms a hollow spring chamber housing an aft bleeding drogue canopy coil spring, and a cord connected between said aft bleeding drogue canopy coil spring and said aft bleeding drogue canopy;
an aft bleeding drogue canopy attached between said plurality of center struts and said plurality of trailing edge struts, said aft bleeding drogue canopy being movable between a first folded configuration and a second open deployed configuration, said aft bleeding drogue canopy coil springs being retracted in said first folded configuration, and said aft bleeding drogue canopy coil springs being extended in said second open deployed configuration; and
a plurality of articulated center strut lever linkage assemblies pivotally connected between a plurality of corresponding adjacent pairs of one of said plurality of center struts and one of said plurality of trailing edge struts, respectively.

10. The passive variable speed drogue of claim 9, wherein each of said center strut lever linkage assemblies comprises a center strut lever arm and a trailing edge strut brace, said center strut lever arm having a radially inward end and a radially outward end, said trailing edge strut brace having a radially inward end and a radially outward end, and said center strut lever arm being pivotally connected at a center pivot point to said radially outward end of said trailing edge strut brace.

11. The passive variable speed drogue of claim 10, wherein said radially outward end of each center strut lever arm is pivotally connected to a corresponding one of said plurality of center struts.

12. The passive variable speed drogue of claim 10, wherein said radially inward end of each trailing edge strut brace is pivotally connected to a corresponding one of said plurality of trailing edge struts.

13. The passive variable speed drogue of claim 10, further comprising an extension spring connected between each said center strut lever arm and a corresponding one of said plurality of center struts, said extension spring being configured to bias said corresponding one of said plurality of center struts to a required stop position in a desired drogue open relationship with a corresponding one of said plurality of trailing edge struts.

14. The passive variable speed drogue of claim 10, each of said plurality of center struts further comprising a radially outwardly extending center strut bumper configured to interface with a stowage tube.

15. The passive variable speed drogue of claim 9, wherein the trailing edge portion of the refueling coupling member includes a plurality of flanges symmetrically arrayed around the trailing edge portion of the refueling coupling member, each of the flanges of the refueling coupling member having an aperture, and further comprising an attachment ring extending through said apertures of said flanges of the refueling coupling member, wherein the leading ends of the leading edge struts each include an aperture aligned with the apertures of the flanges the refueling coupling member, said attachment ring extends through said apertures of said plurality of leading edge struts, and said plurality of leading edge struts are pivotally mounted to said plurality of leading edge struts by said attachment ring.
